(19) United States
(12) Patent Application Publication
(10) Pub. No.: US 2013/0206878 A1
(43) Pub. Date: Aug. 15, 2013

(54) Method for cleaning up materials that result from the recycling of furniture, in particular mattresses, bed bases and seats

(71) Applicants: Rémy Lanza, Bollene (FR); Salim Touati, Livron Sur Drome (FR)

(72) Inventors: Rémy Lanza, Bollene (FR); Salim Touati, Livron Sur Drome (FR)

(73) Assignee: ECOVAL ENVIRONNEMENT, LOGNES (FR)

(21) Appl. No.: 13/812,900

(22) PCT Filed: Jul. 25, 2011
(86) PCT No.: PCT/FR2011/051786

§ 371 Date: Apr. 10, 2013

(30) Foreign Application Priority Data
Jul. 29, 2010 (FR) 10 56250

(51) Int. Cl. B02C 23/00

(52) U.S. Cl. CPC B02C 23/00
USPC 241/23

(57) ABSTRACT

The invention relates to a method for cleaning up recycled materials that result front the recycling of furniture, the method comprising the following steps:
a step of providing recycled materials that result from the recycling of furniture, these materials containing an initial quantity of at least one chemical compound from the following list: VOCs (volatile organic compounds), formaldehyde, dimethylformamide, chlorophenol;
a step of grinding the recycled materials;
a thermal treatment step, during which the ground recycled materials are brought to a temperature of greater than 150° C., the ground recycled materials having, after the thermal treatment step, a final quantity of said chemical compound which is less than the initial quantity.

The present invention generally relates to the field of furniture.

More specifically, the invention relates to a method for cleaning up materials from the recycling of furniture, in particular mattresses, bed bases and seats.

Furniture at the end of its life, in particular mattresses and bed bases, is taken to the dump or incinerated. These solutions are not satisfactory from an ecological perspective. End-of-life furniture, mattresses and bed bases make up a very significant flow each year. They are made up of materials very different from one another, such as steel, wood, textiles, polyurethane foams, latex, etc. Incinerating these materials causes gas discharges, some of which may be toxic. When the mattresses and bed bases are taken to the dump, they take up a significant amount of space and are poorly suited to the existing treatment channels. Furthermore, some materials are not biodegradable over time.

To resolve this problem, it is currently considered to recycle the material and produce different types of finished products from materials coming from end-of-life furniture.

However, some recycled materials include significant quantities of regulated chemical compounds. These compounds are for example VOCs (volatile organic compounds), in particular formaldehyde, DMF (dimethylformamide), or chlorophenol. Formaldehyde may for example be found in the residue of adhesives used to assemble furniture, as well as in the polyurethane foams, latex, and the binders used in pressed wood. The current regulations only allow the presence of these chemical compounds in very small quantities in products put on the market.

In this context, the invention aims to propose a method making it possible to clean up the recycled materials resulting from recycling furniture, making it possible to eliminate certain regulated chemical compounds in a sufficient proportion to allow placement of the finished products manufactured from recycled materials on the market.

To that end, the invention relates to a method for cleaning up recycled materials that result from the recycling of furniture, the method comprising the following steps:
a step of providing recycled materials that result from the recycling of furniture, these materials containing an initial quantity of at least one chemical compound from the following list: VOCs (volatile organic compounds), formaldehyde, dimethylformamide, chlorophenol;
a step of grinding the recycled materials;
a thermal treatment step, during which the ground recycled materials are brought to a temperature of more than 150° C., the ground recycled materials having, after the thermal treatment step, a final quantity of said chemical compound which is less than the initial quantity.

The method may also include one or more of the following features, considered individually or according to any allowable combinations:
during the thermal treatment step, the ground recycled materials are maintained at a temperature of more than 150° C. for a period of 30 to 60 seconds;
it comprises a step for heating the ground materials using microwaves, preceding the thermal treatment step;
in the microwave heating step, the ground materials are heated to a temperature of more than 70° C.;
at least some of the recycled materials belong to one of the following families: a first family made up of materials primarily containing polyurethane, a second family made up of materials primarily containing latex, a third family made up of materials containing textile fibers, a fourth family made up of materials primarily containing wood;
the recycled materials are a mixture of at least two of the following families: a first family made up of materials primarily comprising polyurethane, a second family made up of materials primarily containing latex, a third family made up of materials containing textile fibers, a fourth family made up of materials primarily containing wood;
it comprises a step for forming a ply of unconsolidated material from the ground recycled materials, before the thermal treatment step;
in the step for forming the ply of unconsolidated material, the ground recycled material is driven and dispersed by a flow of air and deposited in a chamber, using the air lay method;
the bi-component fibers are added to the ground recycled materials before the step for forming a ply of unconsolidated material, the thermal treatment step resulting in consolidating the ply of unconsolidated material;
it comprises a step for checking the recycled materials, during which the initial quantities of said chemical compounds in the recycled materials are estimated.

Other features and advantages of the invention will emerge from the detailed description thereof provided below, for information and non-limitingly, in reference to the appended figures, in which:

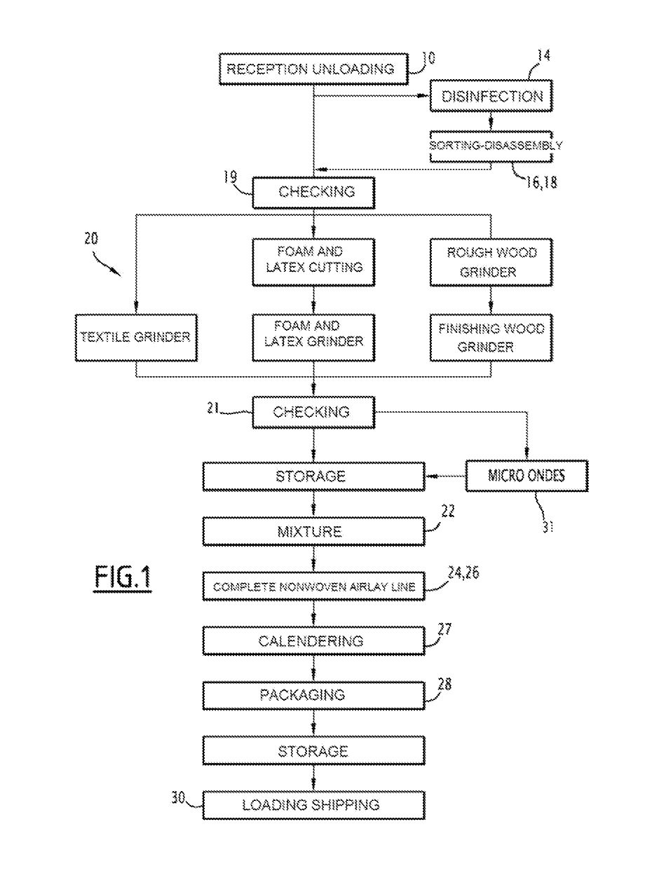

FIG. 1 is a flowchart, illustrating the method according to the invention;

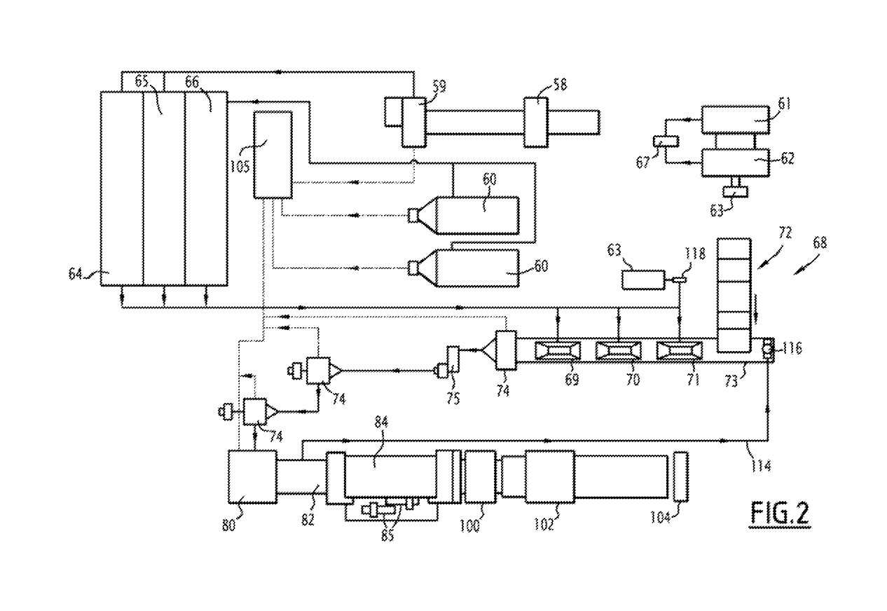

FIG. 2 is a simplified diagrammatic illustration of the production lines for the grinding, mixing, unconsolidated ply formation and consolidation steps;

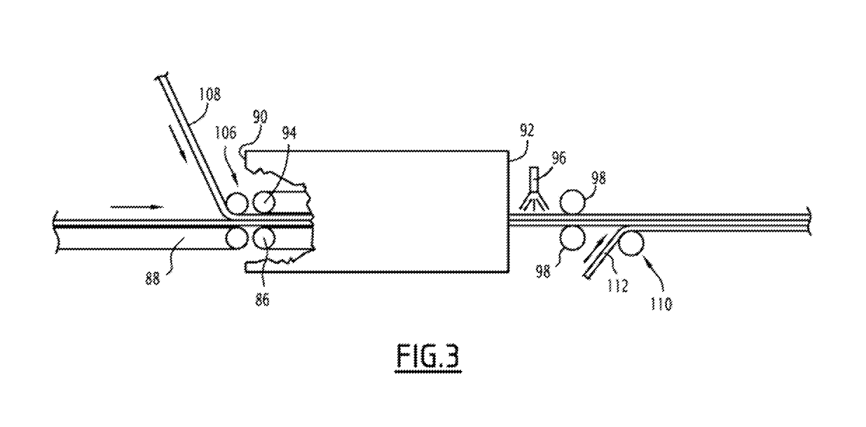

FIG. 3 is a simplified diagrammatic illustration of the consolidation step of the ply of unconsolidated materials.

The method that will be described below, the primary steps of which are diagrammatically illustrated in FIG. 1, is designed to recycle end-of-life furniture.

This furniture may be bedding items, such as mattresses and bed bases inter alia.

However, the method makes it possible to treat other types of products: sofas, sofa beds, armchairs, seats, scraps resulting from the manufacture of new mattresses and bed bases, this list not being exhaustive.

The furniture may also be any other type of furniture including parts made from wood, for example sideboards, closets, wardrobes, cupboards, etc. Furniture here refers both to complete furniture including all of its parts (doors, side and rear panels, bottom, intermediate shelves, etc.), and isolated furniture items that do not form a complete piece of furniture by themselves (a door, panel, etc.). The method is also suitable for recycling manufacturing scraps containing wood, for example manufacturing scraps from bed frames or furniture, in addition to the furniture or furniture items.

In the following description, “item to be treated” will refer to complete furniture, furniture items, mattresses, bed bases, seats and manufacturing scraps.

The recycled furniture may be made up entirely of wood parts, or on the contrary include both wood parts and parts made from another material (fabrics, plastic, metal, etc.). The wood parts may be bare, painted, dyed, covered with a decorative coating made from plastic or fabric, etc.

The wood parts may be solid wood, for example such as pine, oak, cherry, pear tree, etc.

The wood parts may also be made from pressed wood. Pressed wood refers to parts made from wood particles (fibers, shavings, fragments), assembled using a binder such as a glue. These parts may be assembled under pressure and a high temperature. Glulam, average density fiber panels, counterveneer and oriented strandboards are examples of pressed wood, this list not being exhaustive.

As illustrated in FIG. 1, the method includes the following steps:
a step 10 for receiving and unloading the items to be treated;
a step 14 for disinfecting the items to be treated;
a disassembly step 16, in which the base materials are obtained by disassembling the items to be treated;
a sorting step 18, in which the base materials are separated into several families of materials, depending on the nature of the base materials;
a preliminary checking step 19, aiming to detect a plurality of predetermined chemical compounds in certain materials of the base items;
a step 20 for grinding the different families of materials;
an intermediate checking step 21, aiming to measure the quantity of said predetermined chemical compounds remaining in the ground materials after grinding;
a mixing step 22, in which a mixture is prepared, the mixture comprising a predetermined quantity of at least one family of ground materials, and, more generally, predetermined respective quantities of several families of ground materials;
a step 24 forming a ply of unconsolidated material from the mixture;
a step 26 for consolidating the ply of unconsolidated material;
a step 27 for calendaring the consolidated material ply;
a step 28 for packaging the ply of consolidated material and a step 30 for loading and shipping the ply of consolidated material;
a microwave cleansing step 31.

These different steps will now be outlined in turn.

In step 10, the items to be treated or received and unloaded from the transport means.

The items to be treated may include:
spring mattresses, which generally comprise a textile outer enclosure, and springs housed in the outer enclosure;
bagged spring mattresses, which comprise groups of springs enclosed in textile bags, and a textile enclosure inside which the bagged springs are placed;
foam mattresses, which comprise a textile enclosure and foam core housed inside the textile enclosure, the foam including a majority of polyurethane; the foam generally includes more than 90% polyurethane and may include up to 100% polyurethane;
latex mattresses, which include a textile enclosure, and a latex core housed inside the textile enclosure;
bed bases, which generally include a rigid frame made from wood or metal, and may include wooden slats, a textile enclosure, metal spiral springs, etc.;
furniture including parts made from wood, for example sideboards, closets, wardrobes, cupboards, etc.

The end-of-life items to be treated, for example used mattresses and bed bases, are then oriented toward the disinfection step 14. The items to be treated that are not at the end of their lives, for example new mattress and bed base manufacturing scraps, are sent directly to the checking step 19, without going through the disinfection step 14, or through the disassembly 16 and sorting 18 steps.

The purpose of the disinfection step is to destroy the bacteriological germs that may be present in the items to be treated. The disinfection must be sufficient from a sanitary perspective to protect the operators working at the various steps of the method, and to guarantee complete hygiene of the recycled finished products.

The disinfection step is not a sterilization step and does not aim to destroy all of the germs present in the items to be treated.

The disinfection step aims to eliminate at least 99% of bacteriological germs, preferably at least 99.9% of bacteriological germs, and still more preferably at least 99.99% of bacteriological germs.

The disinfection step is done either chemically or using electromagnetic waves.

The bed bases, spring mattresses, and bagged spring mattresses are treated chemically. Foam mattresses and latex mattresses are treated either chemically or using electromagnetic waves.

The chemical disinfection consists of spraying a disinfectant on the outer surface of the items to be treated. This operation is carried out in a hermetic chamber. After spraying, the item to be treated remains in the chamber for approximately 2 h30.

The disinfectant is for example the product bearing commercial name ANIOS DVA HPH, sold by the laboratory ANIOS. The quantity of product used is approximately 8 mL for a normal size mattress.

Disinfection using electromagnetic waves is done by placing the element to be treated in a microwave tunnel.

The maximum power of the microwave generator used is 80 kW. Alternatively, the maximum power of the microwave generator is 60 kW.

The frequency of the magnetron that generates the microwaves is approximately 2450 MHz.

The item to be treated undergoes microwave radiation, which produces a rapid temperature increase within that item. The power of the microwave radiation and the exposure time are chosen as a function of the size of the mattress, its thickness, and the material making up the core (polyurethane foam or latex). The power and duration are chosen so as to maintain the central layer of the mattress at a temperature higher than 70° C. for a period of at least 45 seconds. Preferably, the power and duration are chosen so as to maintain the central layer of the mattress at a temperature comprised between 70° C. and 90° C. for a period comprised between 45 seconds and 90 seconds.

In the disassembly step 16, the items to be treated are disassembled by operators, irrespective of whether those items are disinfected.

In the sorting step 18, the base materials obtained by disassembling the items to be treated are separated, preferably into five families of materials. The sorting is done according to the nature of the base materials. The five families are the following:
a first family made up of the base materials that verify the following two conditions at the same time: the materials do not contain textile fibers, and they contain primarily polyurethane;
a second family made up of base materials primarily containing latex;
a third family made up of base materials containing textile fibers;
a fourth family made up of base materials primarily containing wood;
a fifth family made up of base materials primarily containing metal.

The first family essentially consists of the cores of foam mattresses, and the manufacturing scraps from polyurethane foam mattresses.

The second family is primarily made up of the cores of latex mattresses.

The third family is essentially made up of the textile coverings of mattresses and bed bases. These materials are generally multi-layer materials, certain layers being made from textiles and other layers for example being made from polyurethane foam, cotton wool, etc. In all, these materials for example include between 15 and 25% textile fibers, the rest being made up of foam or other substances.

The fourth family consists of the wooden structures of bed bases and the wooden parts of furniture or furniture items.

The fifth family is essentially made up of the spiral springs found in spring mattresses, bagged spring mattresses, and bed basis, as well as the metal frames of bed bases.

In step 19, the composition of certain materials of the items to be treated is checked. These materials are those likely to contain chemical compounds that are not authorized in the finished product. These chemical compounds are for example VOCs (Volatile Organic Compounds), formaldehyde, DMF and chlorophenol. The materials likely to contain such chemical compounds are for example latex, polyurethane foams, adhesive residues, textiles, pressed woods, etc. Formaldehyde is in particular found in the binders of pressed woods, or in the adhesives used to adhere the layers of certain materials to each other.

The check is done by removing a small quantity of each material to be checked, and analyzing the composition of that sample in an automatic detection device to verify whether the sample contains a chemical compound appearing in a predetermined list. This device may for example be a gas-phase chromatography device coupled with an FID (Flame Ionization Detector).

If the material contains a chemical compound from the list, in a quantity below a predetermined threshold, that material is treated using the recycling method. The grinding and consolidation steps 20 and 26 in fact make it possible to eliminate a significant fraction of the chemical compound, and to make the concentration of said chemical compound in the consolidated nonwoven product ply be within the acceptable standards. The consolidation step uses thermal treatment, as explained later, and is particularly effective to eliminate regulated chemical compounds. The predetermined threshold is specific to each chemical compound. It depends, inter alia, on the removal rate of the chemical compound in the grinding and consolidation steps, and the composition of the consolidated material ply (proportion of the material containing the chemical compound in the ply).

If the material contains a quantity of the chemical compound above the predetermined threshold, then that material is not treated using the recycling method. It is for example sent to a controlled dump, provided to accept materials containing the detected chemical compound.

The acceptable quantities of different regulated chemical compounds in the finished products designed for furniture are indicated in the European CERTIPUR, EUROLATX, ECOLABEL labels and certifications for mattresses.

In the grinding step 20, the different families of materials are treated separately.

The first and second families of materials are treated by the same type of machine, but separately. The materials initially assume the form of blocks. The materials are ground in cubic items, with a particle size between 8 and 12 mm. The operation is carried out in two stages. In the first stage, the blocks are cut into slices by blades, for example in a guillotine-type machine. In a second stage, the slices are reduced into small items, for example in a circular cutting granulator and calibration hopper.

The third family of materials is for example treated in a shredder equipped with blades. The materials leave the shredders in the form of stock fibers.

The fourth family of materials is grounded shavings with a length comprised between 10 and 20 mm and a width comprised between 2 and 5 mm. The grinding operation is performed in two stages. The materials are first treated in a rotor preform shredder, with a 30 to 50 mm hopper. The materials from the preform shredder then go through a secondary shredder, equipped with a 4 mm to 10 mm hopper. The shavings are collected in bags.

Vibrating separators equipped with magnetic rollers are placed immediately downstream of each shredder. They make it possible to separate the metal parts from the other ground materials.

Alternatively, it is possible to grind bed frames that have a wooden frame, as well as furniture containing wooden parts, directly, without prior disassembly. The grinding is done in the same shredders equipped with magnetic separators as described above. In that case, the sorting between the fourth family of materials (wood) and the fifth family of materials (metal) is done using magnetic rollers. The fourth family of materials then contains not only wood, but also other materials such as the textile trim of bed bases.

For the fifth family of materials, it is possible to provide that the spiral springs in good condition are separated and reused to manufacture new mattresses, new bed bases or any other suitable product. The unusable springs, as well as the other metal parts, are ground in the same shredders as the fourth family of materials. They are then sent to the dump or sold to scrap metal dealers.

At the end of the grinding step 20, the ground materials of the different families are transferred into dedicated storage units.

It should be noted that the grinding step causes the partial elimination of certain chemical compounds. These compounds are for example released in gaseous form.

This is particularly true for compounds found in so-called “hermetic” materials, i.e., trimmed with gas-impermeable coverings. These coverings may for example be varnishes, paints, layers of plastic materials, etc. Certain furniture (e.g., closets) includes panels made from hermetic materials.

The volatile chemical compounds contained in such materials do not evaporate during the life of the furniture, as they are confined inside the materials by the coverings. During the grinding operation, these compounds are partially released.

On the contrary, in so-called “aerated” materials, such as foams, bare solid woods and bare pressed woods, the volatile chemical compounds gradually evaporate over the lifetime of the furniture. The quantity of volatile chemical compounds found in the aerated materials at the end of their lives is much lower than that found in hermetic materials at the end of their lives.

In step 21, the composition of the materials likely to contain chemical compounds not authorized in the finished product is checked once again. This check makes it possible to verify the effectiveness of the grinding tool to eliminate said compounds. It is done as in step 19.

According to the results of the checks, the materials are sent to the mixing step 22 or to the microwave cleansing step 31. If the material contains a chemical compound on the list in a quantity above a predetermined threshold, that material is treated using microwaves to eliminate part of said chemical compound. As in step 19, the predetermined threshold is specific to each chemical compound. It depends, inter alia, on the removal rate of the chemical compound in the consolidation step, and the composition of the consolidated material ply (proportion of the material containing the chemical compound in the ply). The other materials are not treated by microwaves.

In step 22, a mixture is prepared from one or more families of ground materials. Predetermined quantities of the different families of ground materials are mixed with each other, those quantities being selected according to the final product to be obtained.

Furthermore, bi-component fibers are added to the mixture. These bi-component fibers are designed, after heating, to consolidate the ply of materials, as described below.

Alternatively, other materials may be added to the mixture. For example, an additional quantity of textile fiber may be added to the mixture, depending on the finished product to be produced. It is possible to add additives to the mixture that are selected according to the nature of the finished product. For example, the additives may include an anti-mite product, a fireproofing product, etc.

In a first example embodiment, the finished product is a ply of a nonwoven material, with a thickness comprised between 5 and 20 mm. The weight of that ply is typically comprised between 400 and 1200 gr/m², preferably between 600 and 1,000 gr/m², and is typically equal to 800 gr/m².

To produce such a ply, a mixture is chosen that comprises, by weight:
between 40% and 80% of the first family of materials, preferably between 50 and 70% of the first family of materials, and for example 60% of the first family of materials;
between 15 and 45% of the third family of materials, preferably between 25 and 35% of the third family of materials, and typically 30% of the third family of materials;
between 5 and 20% bi-component fibers, preferably between 5 and 15% bi-component fibers, and typically 10% bi-component fibers.

In a second example embodiment, the finished product is a ply of a nonwoven material, with a thickness comprised between 20 and 50 mm. The weight of said ply is comprised between 1200 and 2200 gr/m², preferably between 1400 and 2000 gr/m², and is for example equal to 1700 gr/m².

To produce such a ply, a mixture is chosen that comprises, by weight:
between 30% and 70% of the first family of materials, preferably between 40 and 60% of the first family of materials, and typically 50% of the first family of materials;
between 5 and 25% of the second family of materials, preferably between 10 and 20% of the second family of materials, and typically 15% of the second family of materials;
between 10% and 30% of the third family of materials, preferably between 15% and 25% of the third family of materials, and typically 20% of the third family of materials;
between 5% and 25% of bi-component fibers, preferably 10 and 20% of bi-component fibers, and typically 15% of bi-component fibers.

In a third example embodiment, the finished product is a ply of a nonwoven material, with a thickness greater than 50 mm. The ply for example has a density comprised between 2000 and 4000 gr/m², preferably comprised between 2500 and 3500 gr/m², and typically equal to 3000 gr/m².

To produce this ply, a mixture is chosen that contains, by weight:
between 20% and 60% of the first family of materials, preferably between 30% and 50%, for example 40% of the first family of materials;
between 15% and 35% of the second family of materials, preferably between 20% and 30%, for example 25% of the second family of materials;
between 5% and 25% of the third family of materials, preferably between 10% and 20%, for example 15% of the third family of materials;
between 10% and 30% of bi-component fibers, preferably between 15% and 25%, for example 20% of bi-component fibers.

According to a fourth example embodiment, the finished product is a ply of a wood-based thermoformable material, with a thickness comprised between 5 and 15 mm, for example 10 mm thick.

For such a finished product, a mixture is chosen that comprises, by weight:
between 50% and 95% of the fourth family of materials, preferably between 65% and 90% of the fourth family of materials, and still more preferably between 75% and 85% ground wood;
between 5 and 50% bi-component fibers, preferably between 10 and 35% bi-component fibers, and still more preferably between 15% and 25% bi-component fibers.

The bi-component fibers are made up of two components distributed over the entire length of the fiber. Each component may have different physical or chemical properties. The components may also either be alternatives of a same type of polymer, or two completely different types of polymer. One example of such a fiber is marketed by the company MAX MODEL SA under the name “Polyester staple fiber, low melt 4/51 mm 110° C. flame retardant ref 4140.” The use of other thermofusible components may also be considered.

In step 24, a ply of unconsolidated material is formed from the mixture, typically according to the “airway” method. This method consists of forming a ply of nonwoven material by dispersing the mixture in a high velocity air current, and depositing the mixture transported by the air current in a chamber. The air current may be created by an excess pressure upstream of the chamber or by a reduced pressure downstream of the chamber.

Before going on to the step for forming the ply 24, the mixture can go into one or more openers, which each comprise one or more rotary rollers provided with spurs. The primary function of these rollers is to route the textile parts of the first family of materials, so as to separate the textiles and open the fibers. The rollers also make it possible to mix the different materials of the mixture, and to homogenize that mixture.

At the end of step 24, the materials making up the ply are not yet bound to each other and are arranged in bulk on the grate.

In step 26, a ply of nonwoven material is consolidated. This consolidation is done through thermal treatment. The ply of unconsolidated material is heated in a furnace, at a temperature higher than 150° C., for example higher than 160° C., typically approximately 180° C. The ply is maintained at said temperature for a length of time comprised between 30 and 60 seconds. The thermal treatment causes partial fusion of the bi-component fibers, which contributes to binding the various components of the mixture to each other (textile fibers, latex, polyurethane, wood shavings).

This thermal treatment also causes the elimination of certain chemical compounds, for example the VOCs, formaldehyde, DMF or chlorophenol. These compounds may be broken down thermally, or may be released in gas form.

The vapors of the chemical compounds are for example trapped on activated carbon filters.

Concomitantly with the thermal treatment operation, it is possible to laminate a coating layer on the ply of materials. It is possible to laminate all sorts of layers: fabric layers, leather layers, decorative plastic layers, etc. The two surfaces of the ply may thus be covered. Preferably, one of the surfaces is covered upstream of the thermal treatment step, the other immediately downstream of the thermal treatment step.

After the thermal treatment step 26, the ply can go on to a calendaring step 27 and a cutting step, to form pieces with dimensions suitable for their final use. Alternatively, the ply may not be cut, but wound and stored in the form of a roll (packaging step 28).

Lastly, the ply is loaded and shipped, either in the form of a roll, or in the form of already-cut pieces (step 30).

During the cleansing step 31, the ground materials are subjected to microwave radiation. The ground materials are soaked. They are brought to a core temperature above 70° C., and maintained at that temperature for a predetermined period of time. The temperature and duration depend on the nature of the material (wood, foam, latex), the chemical compound(s) to be eliminated, and the expected removal rate. The temperature and duration are chosen so as not to deteriorate the material (burning due to excessive heating).

Under the effect of the heating, the chemical compounds to be eliminated are evaporated and/or decomposed. They are captured and neutralized on activated carbon.

The chemical compounds trapped on the activated carbon are recovered in the form of dusts and treated as final waste. They are handled by specialized companies and packaged using suitable methods.

The compounds trapped on the activated carbon of the furnace used for thermal treatment of the ply are treated in the same way.

The machines used to grind the different families of materials are shown in FIG. 2.

Regarding the first and second families, the blocks are first cut into slices by blades, for example in a guillotine-type machine 58. Secondly, the slices are reduced into smaller items in a granulator 59 of the MG2000 MOLINARI type. The granulator is of the single rotor type equipped with blades and a calibration hopper.

The third family of materials is for example treated in a shredder 60 with rollers equipped with blades, of the SM500McAfee Shredder type. As shown in FIG. 2, the facility may include two parallel lines dedicated to the third family of materials, each with a shredder 60. The materials leave the shredders in the form of stock fibers.

The grinding operation of the fourth family of materials is carried out in two stages. The materials are first treated in a rotor preform shredder 61, of the WAGNER brand and type WS70, with a 30 to 50 mm hopper. The materials coming from the preform shredder then go through a secondary shredder 62, for example Wagner brand and type WS30, equipped with grates of approximately 4 mm. The shavings are collected in bags 63.

The vibrating separators equipped with magnetic rollers, placed immediately downstream of the shredder, are not shown.

The shredders are suitable for treating the materials resulting from the disassembly of the items to be treated, as well as whole, non-disassembled furniture (bed bases, closets, furniture items, etc.).

The materials of the first three families are stored in large containers 64, 65, 66. The shredders 59 and 60 are connected to the containers 64, 65, 66 by ducts. The materials are transferred along the ducts by pulsed air. The containers 64, 65, 66 can each be equipped with agitating means, for example nozzles blowing air movable inside the container. The wood shavings of the fourth family are stored in bags 63 and the metal parts of the fifth family are stored in trays or movable containers 67. Each family of materials is thus stored separately from the other families of materials.

The mixing device 68 is shown diagrammatically in FIG. 2. The device 68 comprises:
three assay devices 69, 70, 71, respectively dedicated to the first, second, and third families of materials;
a device 72 for assaying bi-component fibers;
a conveyor 73 supplied by the assay devices 69, 70, 71 and 72;
at least one opener 74, provided to mix the materials brought in by the conveyor 73;
a device 75 for adding additives.

The assay devices 69, 70, 71 are silos, each having an inner volume provided to receive a quantity of the first family, second family, and third family of materials, respectively. Each silo 69, 70, 71 is equipped with sensors suitable for measuring the weight of the materials loaded inside the inner volume. The silos 69, 70, 71 are connected by transport ducts to the storage areas 64, 65, 66 respectively dedicated to the first, second, and third families of materials. The transfer is done by means of a pulsed air device.

The lower portion of each silo 69, 70, 71 is equipped with an outlet situated overhanging the conveyor 73. Each of the silos is equipped with a control valve, making it possible to open and close the outlet selectively.

The bi-component fibers assume the form of a block of fibrous material. The device 72 dedicated to assaying the bi-component fibers includes a tool provided to nibble the block of bi-component fibers and produce shavings, a cell for weighing the fibers, and a transfer member from the weighing cell to the conveyor 73.

The nibbling tool may be of any suitable type, and for example includes a plurality of tips so as to detach the bi-component fibers from the compressed block.

The fibers detached by the nibbling tool are transferred to the weighing cell, for example by a conveyor belt. They are transported from the weighing cell to the conveyor 73 by a chute or another conveyor belt.

In the example embodiment shown in FIG. 2, the device 68 includes three openers 74 placed serially. The materials deposited on the conveyor 73, at the end of said conveyor, are poured into the first opener 74.

The three openers 74 are of the same type.

The device 75 is for example inserted between the first and second openers 74. It is provided to add a mixture of additives selected according to the nature of the finished product. For example, the additives may include an anti-mite product, a fireproofing product, etc.

The openers 74 and the device 75 are connected to each other by connecting ducts. The mixture is transferred along the ducts by pulsed air.

The device for forming the ply of unconsolidated materials and the thermal treatment device are shown diagrammatically in FIG. 2. The device 80 for forming the ply is of the type described in Italian patent application no. PO2007/A000021. This device includes two vacuum chambers, and is particularly well suited to treating a mixture containing a high proportion of polyurethane and latex.

The last opener 74 is connected to the device for forming the ply 80 by a duct. The mixture is transferred along the duct, for example by pulsed air.

The ply 82 leaving the device 80 is transported on a conveyor and penetrates the furnace 84 to undergo the thermal treatment therein. The furnace for example has a total length of 5 m, and is divided into two chambers placed serially with one another. It is heated by gas burners 85. It is equipped with fans to allow the circulation of the heated air through the burners inside the two chambers. The device is equipped with two conveyors placed inside the furnace 84, as shown in FIG. 3. The lower conveyor 86 is placed in the extension of the conveyor 88, which ensures transportation of the ply from the device for forming the ply 80 to the furnace 84. The conveyor 86 transports the ply through the furnace 84 from the inlet 90 to the outlet 92. The upper conveyor 94 is placed above the conveyor 86. The vertical spacing of the conveyor 94 relative to the conveyor 86 is adjustable, such that the conveyor 94 calibrates the thickness of the ply 82 at the inlet of the furnace. The conveyor 94 extend substantially over the entire length of the furnace, from the inlet 90 to the outlet 92.

The ply 82 undergoes cooling upon leaving the furnace 84, first through a projection of cold air using nozzles 96, then by calendaring using cooled rollers 98. Downstream of the calendaring rollers 98, a device 100 (FIG. 2) can be placed capable of routing the ply 82 either toward a cutting unit 102 or toward a storage roller 104.

As shown in FIG. 3, the thermal treatment device may also include an assembly 106 making it possible to eliminate a coating layer 108 on one of the surfaces of the ply 82, here the upper surface. The assembly 106 is placed immediately upstream of the furnace 84. A similar device 110 is placed downstream of the calendaring rollers 98, so as to eliminate another coating layer 112 on the opposite surface of the ply 82, here the lower surface.

As visible in FIG. 2, the scraps of material coming from the device for forming the ply 80 are collected and sent back via the line 114 to the conveyor 73. After grinding in a shredder 116, these materials are recycled on said conveyor 73.

The mixing device 68 also includes a suction unit 118, provided to suction the wood shavings and transfer them to one of the silos 69, 70 and 71.

The wood shavings at the outlet of the shredders are collected in containers, for example in bags 63. These bags 63 are then transported near the conveyor 73, the wood shavings then being able to be suctioned by the device 118.

The recycling facility is also equipped with a centralized ventilation device 105, provided with air extractors suitable for suctioning the air in the primary equipment of the facility: the shredders for the third family of materials, the granulator for the first and second families of materials, the silos, the openers, the device 80 for forming the ply. The dusts are trapped on a filter, for example a bag filter. They may be reused, for example in road covering products.

The plies obtained using the above method may be used for many applications. The plies containing high proportion of polyurethane may be used as components of finished products for furniture, in particular for protecting bed base slats, mattress boosters, or trim for mattress boards. These plies may also be used as thermal and noise insulation for the building sector, or cushioning in the automobile sector.

Plies containing a high proportion of wood shavings may be used for furniture, and are particularly well suited for undergoing thermoforming operations.

The plies described above may also be manufactured from materials that do not result from recycling bedding or furniture items or manufacturing scraps. The materials may be raw materials directly acquired from manufacturers, specifically to produce the plies.

In the first example embodiment, the finished product is a ply of a nonwoven material, with a thickness comprised between 5 and 20 mm. The density is typically comprised between 20 and 60 kg/m³, preferably between 30 and 50 kg/m³, and is for example equal to 40 kg/m³.

In that case, the mixture comprises, by weight:
between 60% and 90% of polyurethane foam, preferably between 70% and 85% of polyurethane foam, and typically between 80% and 85% of polyurethane foam;
between 2% and 15% textile fibers, preferably between 3% and 10% textile fibers, and for example between 4% and 8% textile fibers;
between 5% and 20% bi-component fibers, preferably between 5% and 15% bi-component fibers, for example between 8 and 12% bi-component fibers.

The finished product, i.e., the consolidated ply, without any laminated coatings, has substantially the same mass composition.

For example, the consolidated ply comprises 84 wt % of polyurethane foam, 6 wt % textile fibers, and 10 wt % bi-component fibers.

In the second example embodiment, the finished product is a ply of a nonwoven material, with a thickness comprised between 20 and 50 mm. The density of the ply is comprised between 25 and 65 kg/m³, preferably between 55 and 65 kg/m³, and is typically equal to 46 kg/m³.

Static fatigue tests were carried out for this ply, according to standard NFT56116. The height loss was approximately 1.4 mm. Furthermore, dynamic fatigue tests were carried out for said ply, according to standard NF EN ISO3385. The height loss was approximately 13.5 mm, with a hardness loss of 14.6%.

The mixture for this example embodiment comprises, by weight:
between 45% and 75% of polyurethane foam, preferably between 55% and 75% of polyurethane foam, for example between 65% and 70% of polyurethane foam;
between 5% and 25% latex, preferably between 10% and 20% latex, for example between 13% and 17% latex;
between 1% and 10% textile fibers, preferably between 2% and 7% textile fibers, for example between 3% and 5% textile fibers;
between 5% and 25% bi-component fibers, preferably between 10% and 20% bi-component fibers, for example between 13% and 17% bi-component fibers.

The finished product, i.e., the consolidated ply, without any laminated coatings, may have substantially the same mass composition.

For example, the consolidated ply comprises 66 wt % of polyurethane foam, 15 wt % latex, 4 wt % textile fibers, and 15 wt % bi-component fibers.

In the third example embodiment, the finished product is a ply of a nonwoven material, with a thickness greater than 50 mm. The density of the ply is comprised between 40 and 80 kg/m³, preferably between 50 and 70 kg/m³, and is typically equal to 60 kg/m³.

Static fatigue tests were performed on this ply, according to standard NFT56116. The height loss was approximately 0.5 mm.

Dynamic fatigue tests were also carried out for this ply, according to standard NF EN ISO 3385. The height loss was approximately 8.8 mm. The hardness loss is approximately 14.6%.

For this example embodiment, the mixture comprises, by weight:
between 35% and 65% of polyurethane foam, preferably between 45% and 60% of polyurethane foam, for example between 50% and 55% of polyurethane foam;
between 15% and 35% latex, preferably between 20% and 30% latex, for example between 22% and 27% latex;
between 1% and 8% textile fibers, preferably between 2% and 6% textile fibers, for example between 2% and 4% textile fibers;
between 10% and 30% bi-component fibers, preferably between 15% and 25% bi-component fibers, for example between 17% and 22% bi-component fibers.

The finished product, i.e., the consolidated ply, without any laminated coatings, has substantially the same mass composition.

For example, the consolidated ply comprises 52 wt % of polyurethane foam, 25 wt % latex, 3 wt % textile fibers, and 20 wt % bi-component fibers.

In the fourth example embodiment, the finished product is a ply of a wood-based thermoformable material, with a thickness comprised between 5 and 50 mm, for example 10 mm thick.

The finished product, without any laminated coatings, comprises, by weight:
between 50% and 95% wood, preferably between 65% to 90% wood, for example between 75% and 85% wood;
between 5% and 50% bi-component fibers, preferably between 10% and 35% bi-component fibers, for example between 15% and 25% bi-component fibers.

For example, the consolidated ply comprises 80 wt % wood and 20 wt % bi-component fibers. It should be noted that all of the consolidated plies described above include a significant quantity of bi-component fibers. This contributes to confining the residues of chemical compounds such as VOCs, formaldehyde, dimethylformamide, or chlorophenol inside said ply. The emissions of said chemical compounds from the ply are practically negligible.

1. A method for cleaning up recycled materials that result from the recycling of furniture, the method comprising the following steps:
a step of providing recycled materials that result from the recycling of furniture, these materials containing an initial quantity of at least one chemical compound from the following list: VOCs (volatile organic compounds), formaldehyde, dimethylformamide, chlorophenol;
a step of grinding the recycled materials;
a thermal treatment step, during which the ground recycled materials are brought to a temperature of more than 150° C., the ground recycled materials having, after the thermal treatment step, a final quantity of said chemical compound which is less than the initial quantity.

2. The method according to claim 1, characterized in that, during the thermal treatment step, the ground recycled materials are maintained at a temperature of more than 150° C. for a period of 30 to 60 seconds.

3. The method according to claim 1, characterized in that it comprises a step for heating the ground materials using microwaves, preceding the thermal treatment step.

4. The method according to claim 3, characterized in that in the microwave heating step, the ground materials are heated to a temperature of more than 70° C.

5. The method according to claim 1 characterized in that at least some of the recycled materials belong to one of the following families: a first family made up of materials primarily containing polyurethane, a second family made up of materials primarily containing latex, a third family made up of materials containing textile fibers, a fourth family made up of materials primarily containing wood.

6. The method according to claim 1 characterized in that the recycled materials are a mixture of at least two of the following families: a first family made up of materials primarily comprising polyurethane, a second family made up of materials primarily containing latex, a third family made up of materials containing textile fibers, a fourth family made up of materials primarily containing wood.

7. The method according to claim 1, characterized in that it comprises a step for forming a ply of unconsolidated material from the ground recycled materials, before the thermal treatment step.

8. The method according to claim 7, characterized in that in the step for forming the ply of unconsolidated material, the ground recycled material is driven and dispersed by a flow of air and deposited in a chamber, using the air lay method.

9. The method according to claim 7, characterized in that the bi-component fibers are added to the ground recycled materials before the step for forming a ply of unconsolidated material, the thermal treatment step resulting in consolidating the ply of unconsolidated material.

10. The method claim 1 characterized in that it comprises a step for checking the recycled materials, during which the initial quantities of said chemical compounds in the recycled materials are estimated.
